(19) United States
(12) Patent Application Publication
(10) Pub. No.: US 2006/0055848 A1
(43) Pub. Date: Mar. 16, 2006

(54) Liquid crystal display and method for manufacturing the same

(76) Inventors: Sang-il Kim, Yongin-si (KR); Young-chol Yang, Seongnam-si (KR); Jeong-ye Choi, Hwaseong-si (KR); Mun-pyo Hong, Seongnam-si (KR); Wang-su Hong, Suwon-si (KR)

Correspondence Address: MCGUIREWOODS, LLP, 1750 TYSONS BLVD, SUITE 1800, MCLEAN, VA, 22102, US

(21) Appl. No.: 11/217,397

(22) Filed: Sep. 2, 2005

(30) Foreign Application Priority Data
Sep. 15, 2004 (KR) 2004-0073804

(51) Int. Cl. G02F 1/1335

(52) U.S. Cl. 349/107

(57) ABSTRACT

A transflective liquid crystal display and a method of manufacturing the same. The liquid crystal display includes a pair of substrates in which a plurality of pixels having a reflection region and a transmission region are defined, a color filter, formed on one of the substrates, having a stepped surface, a phase difference layer planarizing the stepped surface of the color filter and having a different phase differences for the reflection region and the transmission region, and a liquid crystal layer interposed between the pair of substrates.

### CROSS REFERENCE TO RELATED APPLICATION

This application claims priority to and the benefit of Korean Patent Application No. 10-2004-0073804, filed on Sep. 15, 2004, in the Korean Intellectual Property Office, which is hereby incorporated by reference for all purposes as if fully set forth herein.

### BACKGROUND OF THE INVENTION

1. Field of the Invention

The present invention relates to a liquid crystal display and a method of manufacturing the same. More particularly, the present invention relates to a transflective liquid crystal display and a method of manufacturing the same.

2. Discussion of the Background

Generally, transmissive liquid crystal displays (LCDs), which create an image using a backlight, were mainly used as displays for personal computers. Recently, with the rapidly increasing demand for display devices for mobile electronic equipment, such as personal data assistants (PDAs) and mobile telephones, reflective LCDs, which create an image by reflecting externally applied incident light, have received much attention. Since reflective LCDs do not use a backlight, they consume less power than transmissive LCDs, which permits longer operating times for electronic equipment having a reflective LCD, as compared to a transmissive LCD.

As noted above, reflective LCDs create an image using ambient light. Therefore, in order to display an image in a dark environment, light may be supplied by installing a front light at a display portion of a LCD panel. However, installing such a front light may undesirably lower reflectivity and contrast, thereby resulting in poor image quality.

A transflective LCD has been developed to solve this problem. The transflective LCD may be used in reflective and transmissive modes because it has a transmission area at a part of a reflective plate in a pixel area. With such a transflective LCD, since a backlight may be installed behind a display portion, the image quality may not suffer, unlike in the reflective LCD. Furthermore, good visibility may be ensured in dark and bright environments, thereby realizing a high-quality image.

FIG. 1 is a sectional view showing a conventional transflective LCD 100. Referring to FIG. 1, the transflective LCD 100 includes a front and rear substrate pair in which a reflection region B and a transmission region D are defined. A reflective electrode (reflective plate) 112, corresponding to the reflection region B, and a transparent electrode 111, corresponding to the transmission region D, are formed on a surface of the rear substrate 110 facing a front substrate 120. A λ/4 layer 113 and a polarization plate 114 may be sequentially deposited on the other surface of the rear substrate 110.

A common electrode 121 may be formed on a surface of the front substrate 120 facing the rear substrate 110. A λ/4 layer 122 and a polarization plate 123 may be sequentially deposited on the other surface of the front substrate 120. A liquid crystal layer 130, made of a liquid crystal material, may be interposed between the rear substrate 110 and the front substrate 120. Further, a backlight 140 may be formed on a lower surface of the rear substrate 110.

The transflective LCD 100 of FIG. 1 has two phase difference layers, including the λ/4 layer 113 formed on the rear substrate 110 and the λ/4 layer 122 formed on the front substrate 120. Alternatively, as shown in FIG. 2, four phase difference layers, including a λ/4 layer 113 and a λ/2 layer 115 formed on a rear substrate 110 and a λ/4 layer 122 and a λ/2 layer 124 formed on a front substrate 120, may be used. These additional layers may provide a higher quality dark display by preventing wavelength dispersion.

The transflective LCD 100 of FIG. 1 includes the λ/4 layer 122 to prevent wavelength dispersion, thereby realizing reflection display. But the λ/4 layer 122 is not necessary for transmission display. However, due to its presence on the front substrate 120, the λ/4 layer 113 may be required on the rear substrate 110 to compensate for a phase difference of the λ/4 layer 122. In other words, a phase difference layer may be added to a rear substrate to compensate for a phase difference of a phase difference layer, which is used for reflection but not transmission display, formed on a front substrate.

Similarly, in a transflective LCD 100′ of FIG. 2, the two phase difference layers 113 and 115, formed on the rear substrate 110, compensate for a phase difference of the two phase difference layers 122 and 124, which are utilized for reflection display but are unnecessary for transmission display.

As described above, a conventional transflective LCD may have more phase difference layers than reflective or transmissive LCDs, which increases manufacturing costs and cell thickness.

### SUMMARY OF THE INVENTION

The present invention provides a liquid crystal display that may be manufactured easily and exhibits good display characteristics.

The present invention also provides a method for manufacturing the liquid crystal display.

Additional features of the invention will be set forth in the description which follows, and in part will be apparent from the description, or may be learned by practice of the invention.

The present invention discloses a liquid crystal display including a first substrate, a plurality of pixels, each pixel having a reflection region and a transmission region, and a color filter, formed on the substrate, having a stepped surface. A phase difference layer planarizes the stepped surface of the color filter and has a first phase difference for the reflection region and a second phase difference for the transmission region. The first phase difference differs from the second phase difference.

The present invention also discloses a method for manufacturing a liquid crystal display, the method comprising forming a color filter with a stepped surface on a first substrate, and forming a plurality of pixels, where each pixel has a reflection region and a transmission region. A phase difference layer is formed to planarize the stepped surface of the color filter, and it has a first phase difference for the reflection region and a second phase difference for the transmission region. The first phase difference differs from the second phase difference.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a sectional view showing a conventional transflective LCD.

FIG. 2 is a sectional view showing another conventional transflective LCD.

FIG. 3 is a sectional view showing a transflective LCD according to an exemplary embodiment of the present invention.

FIG. 4 is a sectional view showing a transflective LCD according to another exemplary embodiment of the present invention.

FIG. 5 is an optically exploded perspective view illustrating an optical construction of the LCD of FIG. 4 under no voltage application.

FIG. 6 is an optically exploded perspective view illustrating an optical construction of the LCD of FIG. 4 under voltage application.

FIG. 7 is a flow diagram illustrating a method for manufacturing an LCD according to an exemplary embodiment of the present invention.

FIG. 8A, FIG. 8B, FIG. 8C, FIG. 8D and FIG. 8E are sequential sectional views showing intermediate structures in a method for manufacturing an LCD according to an exemplary embodiment of the present invention.

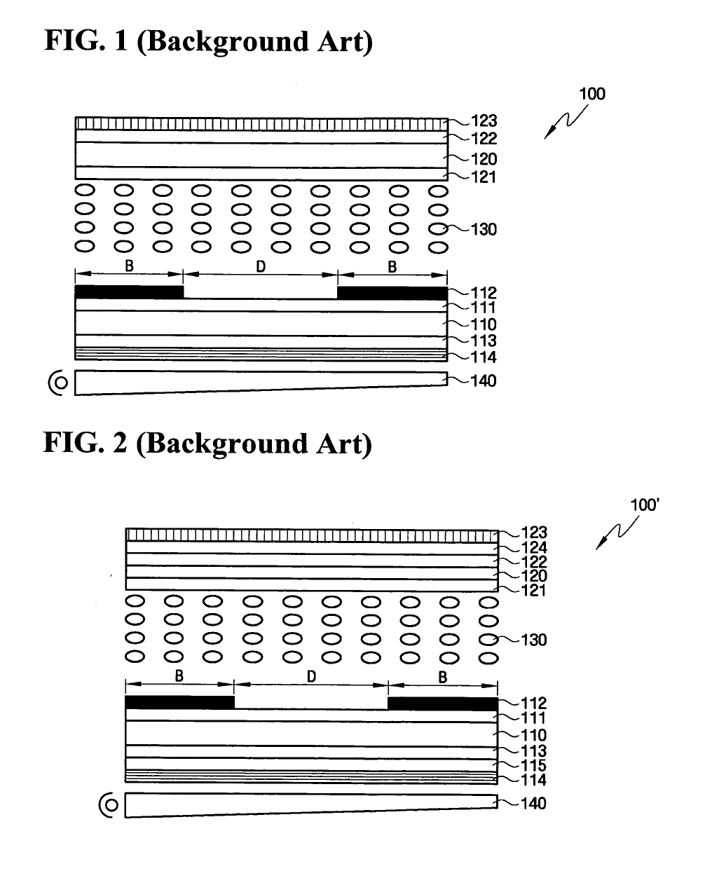

### DETAILED DESCRIPTION OF THE ILLUSTRATED EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these embodiments are provided so that this disclosure will be thorough and complete and will fully convey the concept of the invention to those skilled in the art. Like reference numerals refer to like elements throughout the specification.

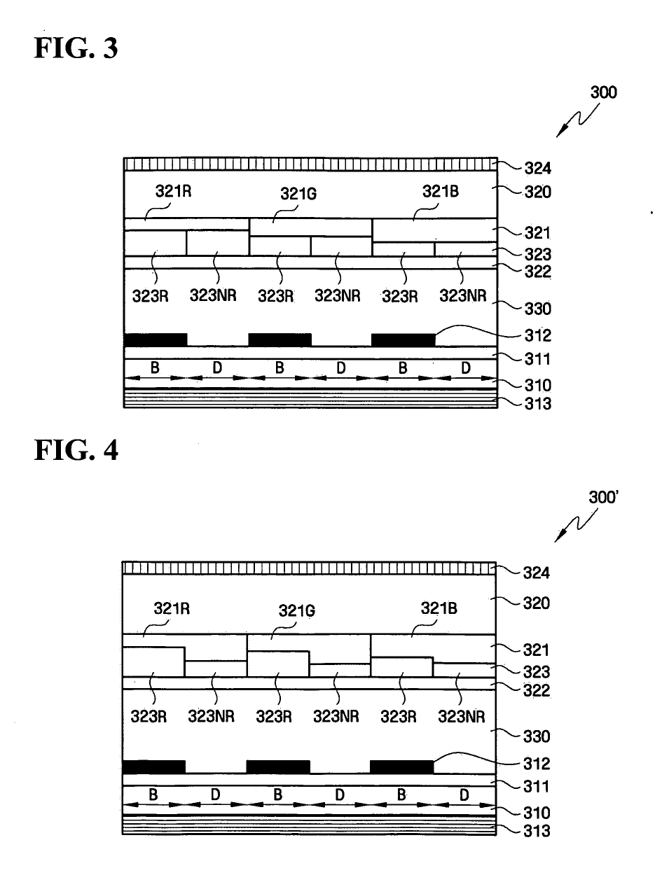

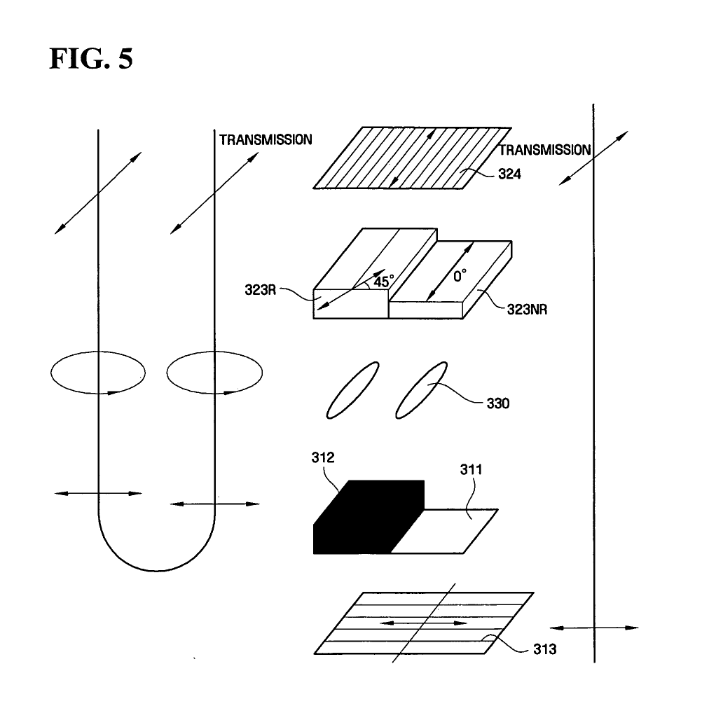

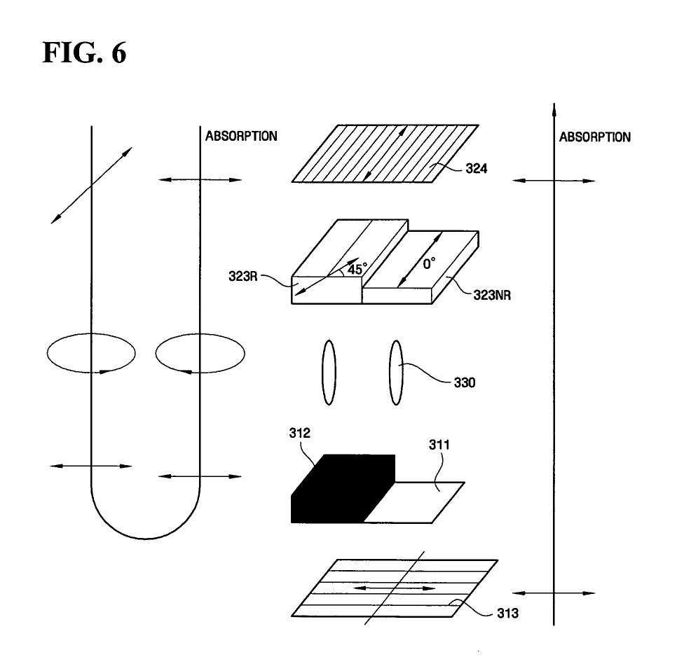

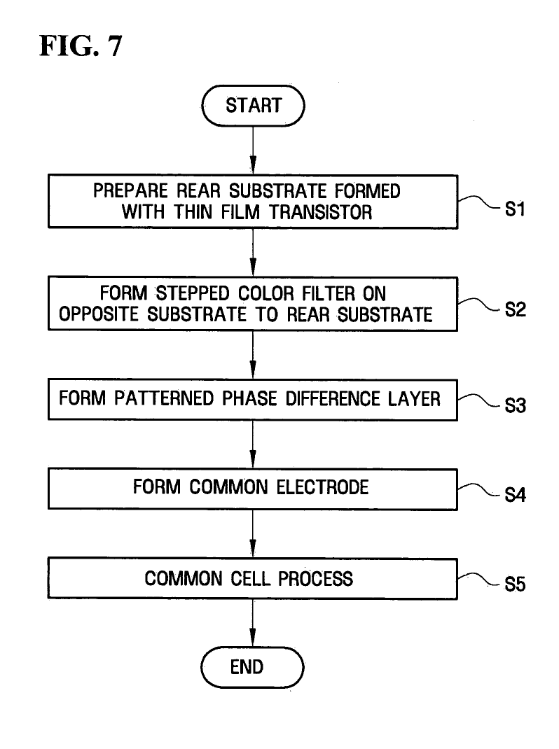

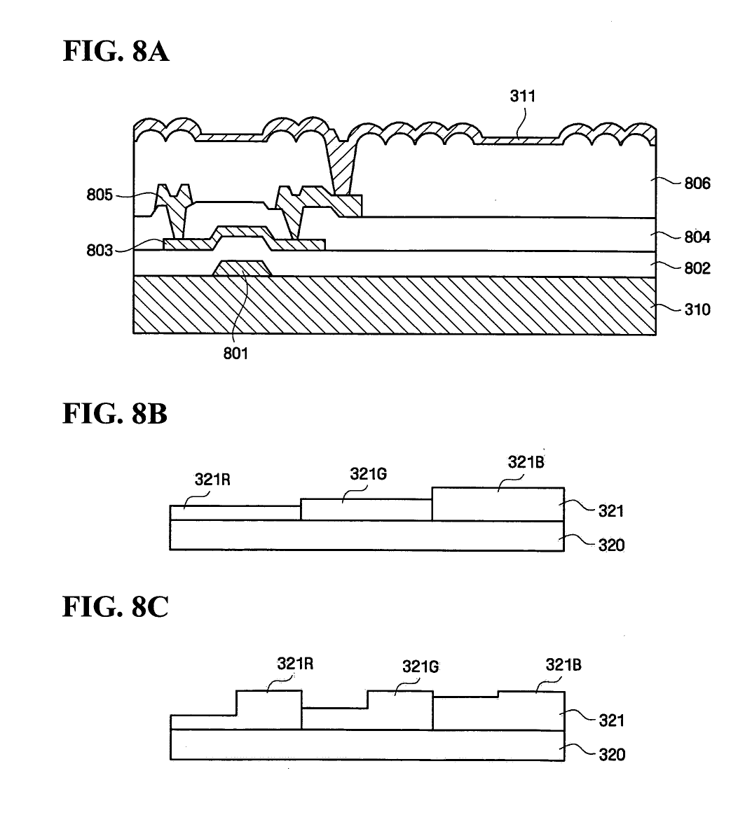

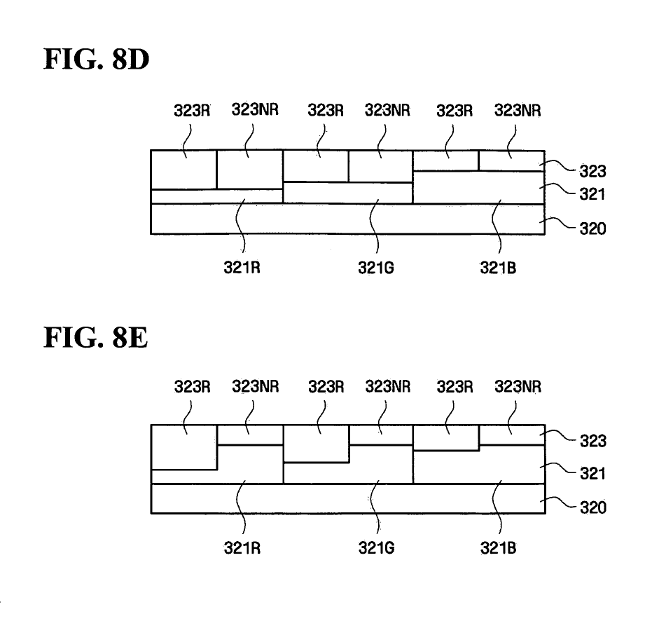

Hereinafter, exemplary embodiments of the present invention will be described in detail with reference to FIG. 3, FIG. 4, FIG. 5, FIG. 6, FIG. 7, FIG. 8A, FIG. 8B, FIG. 8C, FIG. 8D and FIG. 8E.

FIG. 3 is a sectional view showing a transflective LCD 300 according to an exemplary embodiment of the present invention.

Referring to FIG. 3, the LCD 300 may include a reflective electrode 312 and a transparent electrode 311 formed on a surface of a rear substrate 310 facing a front substrate 320. The reflective electrode 312 may be made of a high reflectivity material, and it corresponds to a reflection region B. The transparent electrode 311 may be made of a high transmittance material, and it corresponds to a transmission region D. A rear polarization plate 313 may be formed on the other surface of the rear substrate 310.

A color filter 321 comprising red, green, and blue pixels 321R, 321G, and 321B may be formed on a surface of a front substrate 320 facing the rear substrate 310. The front substrate 320 may be used as a display plate creating an image by incident light originated from ambient light. As FIG. 3 shows, the red, green, and blue pixels 321R, 321G, and 321B of the color filter 321 may have different thicknesses. In this respect, the color filter 321 has a stepped surface. Therefore, when a phase difference layer, as will be described later, has different thicknesses corresponding to the red, green, and blue pixels 321R, 321G, and 321B, the phase difference of center wavelength of each of the red, green, and blue pixels may be adjusted to λ/4.

Referring to FIG. 4, a color filter 321 may have a two stepped structure for each red, green, and blue pixel 321R, 321G, and 321B. In other words, each red, green, and blue pixel 321R, 321G, and 321B has different thicknesses for a reflection region B and a transmission region D. Therefore, the color filter 321 may have different characteristics for the reflection region B and the transmission region D. If d is a distance traveled by incident light passing through the transmission region D, then 2 d may be a distance traveled by incident light passing through the reflection region B, because the incident light passing through the reflection region B reflects from a reflective electrode 312 before being outwardly emitted. Hence, if the red, green, and blue pixels 321R, 321G, and 321B constituting the color filter 321 for the reflection region B and the transmission region D have the same thickness, a color density of the reflection region B may increase and reflectivity may decrease. That is to say, in order to adjust color density or reproducibility and to increase reflectivity in the reflection region B, each of the red, green, and blue pixels 321R, 321G, and 321B may be formed in a two stepped structure.

Lower layers of two stepped structures of the red, green, and blue pixels 321R, 321G, and 321B may have different thicknesses. As used herein, the term “lower layer of two stepped structure” refers to a portion of each color pixel corresponding to the reflection region B.

As described above, the color filter 321 comprising two stepped red, green, and blue pixels 321R, 321G, and 321B has a stepped surface. Therefore, when a phase difference layer, as will be described later, has different thicknesses for the red, green, and blue pixels is 321R, 321G, and 321B, the phase difference of center wavelength of each of the red, green, and blue pixels may be adjusted to λ/4.

Referring to FIG. 3 and FIG. 4, a phase difference layer 323 may be formed on the color filter 321 to planarize the color filter's stepped surface. Therefore, a separate overcoat layer is not needed. The phase difference layer 323 has different phase differences for the reflection region B and the transmission region D. That is, the phase difference layer 323 may be patterned such that it corresponds to a phase difference layer 323R, which has a phase difference of λ/4 in the reflection region B, and a phase difference layer 323NR, which has no phase difference in the transmission region D. The phase difference layer 323 may be made of a liquid crystal polymer, which may be obtained by curing a UV-curable liquid crystal monomer exhibiting a nematic phase.

According to exemplary embodiments of the present invention, the phase difference layer 323 may be patterned so that it has different phase differences for the reflection region B and the transmission region D. Consequently, unlike in a conventional LCD, a separate phase difference layer is not formed on a rear substrate to compensate for the phase difference of a phase difference layer formed on a front substrate for reflection display. Therefore, fewer phase difference layers may be used.

A common electrode 322 may formed on a lower surface of the phase difference layer 323.

A front polarization plate 324 may be disposed on an upper surface of the front substrate 320. A liquid crystal layer 330, made of a liquid crystal material, may be interposed between the rear substrate 310 and the front substrate 320. A backlight (not shown) for transmission display may be disposed outside the rear polarization plate 313.

Actual image display using a liquid crystal display 300′ of FIG. 4 will now be described with reference to FIG. 5 and FIG. 6, which omit the rear and front substrates 310 and 320, the color filter 321, and the common electrode 322 for simplicity.

Liquid crystals constituting the liquid crystal layer 330 of the LCD 300′ may have a vertical or horizontal orientation when no voltage is applied to the liquid crystal layer 330. FIG. 5 and FIG. 6 illustrate the case where the liquid crystals have a horizontal orientation.

For further discussion, the following assumptions are made. When light passes through the liquid crystal layer 330 in a state where no voltage is applied to the liquid crystal layer 330, the liquid crystal layer's phase difference is adjusted to λ/4 for the reflection region B and λ/2 for the transmission region D. When a voltage is not applied, the liquid crystals are aligned approximately parallel to the rear and front substrates 310 and 320, and their orientation is parallel to the orientation of the phase difference layer 323R for the reflection region B. Additionally, the orientation azimuth of the liquid crystals makes an angle of about 45 degrees with respect to the transmission axis of the front polarization plate 324.

First, a bright display when no voltage is applied to the liquid crystal layer 330 will be described with reference to FIG. 5.

In the reflection region B, incident light, originated from ambient light, into the front substrate 320 used as a display plane is linearly polarized parallel to the transmission axis of the front polarization plate 324. The linearly polarized light is circularly polarized in the phase difference layer 323R of the reflection region B. The liquid crystal layer 330 converts the circularly polarized light to a linearly polarized light before it reaches the reflective electrode 312. The linearly polarized light, reversed by the reflection electrode 312, undergoes circular polarization in the liquid crystal layer 330. The circularly polarized light is linearly polarized parallel to the transmission axis of the front polarization plate 324 by the phase difference layer 323R before it passes through the front polarization plate 324.

In the transmission region D, light supplied by the backlight behind the rear substrate 310 is linearly polarized parallel to the transmission axis of the rear polarization plate 313. The linearly polarized light is then linearly polarized perpendicular to the transmission axis of the rear polarization plate 313, i.e., parallel to the transmission axis of the front polarization plate 324, by the liquid crystal layer 330, before it passes through the front polarization plate 324.

Next, a dark display when a voltage is applied to the liquid crystal layer 330 will be described with reference to FIG. 6.

In the reflection region B, incident light from a display plane side is linearly polarized parallel to the transmission axis of the front polarization plate 324. The linearly polarized light then undergoes circular polarization in the phase difference layer 323R. The circularly polarized light maintains its polarization state almost unchanged in the liquid crystal layer 330 and is reflected from the reflective electrode 312. The circularly polarized light reflected by the reflective electrode 312 is a reversed circularly polarized light. The reversed circularly polarized light again passes through the liquid crystal layer 330, and the phase difference layer 323R converts it to a linearly polarized light perpendicular to the transmission axis of the front polarization plate 324. Hence, the light is absorbed in the front polarization plate 324.

In the transmission region D, incident light supplied by the backlight is converted to a linearly polarized light parallel to the transmission axis of the rear polarization plate 313. The linearly polarized light maintains its polarization state almost unchanged in the liquid crystal layer 330 and then is absorbed in the front polarization plate 324.

As described above, the phase difference layer 323R having the phase difference of λ/4, necessary for dark display, is formed in the reflection region B. However, the phase difference layer 323NR of the transmission region D has no phase difference. Therefore, the reflection region B may have sufficient reflectivity due to the phase difference layer 323R of the reflection region B, while the transmission region D may realize transmission display without additionally installing a new phase difference layer on the rear substrate 310 to compensate for the phase difference of the phase difference layer 323NR. Accordingly, high contrast display in reflection and transmission modes may be obtained. Furthermore, there is no need to add a phase difference layer to the rear substrate 310, thereby resulting in thinner cells and cheaper manufacturing costs.

Hereinafter, methods for manufacturing LCDs according to the exemplary embodiments of the present invention will be described in detail with reference to FIG. 7 and FIG. 8A, FIG. 8B, FIG. 8C, FIG. 8D and FIG. 8E. FIG. 7 is a flow diagram illustrating methods for manufacturing the LCDs according to the exemplary embodiments of the present invention shown in FIG. 3 and FIG. 4, and FIGS. 8A through 8E are sequential sectional views of intermediate structures in the LCD manufacturing methods of FIG. 7.

First, a rear substrate formed with a thin film transistor (TFT) may be prepared (operation S1), as shown in FIG. 7.

Referring to FIG. 8A, a gate electrode 801, a gate insulating layer 802, and a semiconductor layer 803 may be sequentially formed on a substrate 310. The semiconductor layer 803 may be formed by depositing amorphous silicon on the gate insulating layer 802, followed by patterning and crystallization by annealing with excimer laser. An n-type impurity (e.g., phosphorus) or a p-type impurity (e.g., boron) may be implanted in the semiconductor layer 803 at both sides of the gate electrode 801 to form an n- or p-channel TFT. A first inter-insulating layer 804, which may be made of SiO₂ or other like materials, may be formed on the substrate 310 to cover the TFT.

Next, portions of the first inter-insulating layer 804 corresponding to a source and a drain region of the semiconductor layer 803 may be removed by, for example, etching, to pattern a signal line 805 to a predetermined shape. Then, a second inter-insulating layer 806 may be formed to cover the TFT and the signal line 805. The second inter-insulating layer 806 may serve as a scattering layer, inducing scattering reflection, and as an inter-insulating layer. A transparent electrode 311 may be formed on a portion of the second inter-insulating layer 806 corresponding to a transmission region (D of FIG. 3 and FIG. 4) and a reflective electrode (not shown) may be formed on a portion of the second inter-insulating layer 806 corresponding to a reflection region (B of FIG. 3 and FIG. 4). As a result, a backlight substrate as shown in FIG. 3 and FIG. 4 may be obtained.

Next, a stepped color filter may be formed on a surface of a substrate 320 (hereinafter, referred to as “color filter substrate”) facing the rear substrate in operation S2.

Specifically, referring to FIG. 8B, a black matrix (not shown) may be formed on a color filter substrate 320. Next, a photoresist composition for color filter may be coated on the black matrix and patterned to form red, green, and blue pixels 321R, 321G, and 321B having different thicknesses, thereby forming the color filter 321 with a stepped surface. At this time, the thickness of the red, green, and blue pixels 321R, 321G, and 321B may be adjusted so that the phase difference of center wavelength of each of the red, green, and blue pixels for the reflection region B is λ/4 when the stepped surface of the color filter 321 is subsequently planarized.

As FIG. 8C shows, the red, green, and blue pixels 321R, 321G, and 321B may also be formed in two stepped structure. First, a pigment-containing photoresist solution may be coated on the color filter substrate 320 followed by a pre-bake process to remove a residual solvent on a coating film. Then, the coating film is exposed to light using a slit pattern or lattice pattern mask with transparent portions and light blocking portions, which are 1-100 μm wide in x-axis and y-axis directions while varying the areas of the transparent portions and the light blocking portions. The degree of curing in pattern portions, slit portions, and unexposed portions may be different due to the exposure energy difference. The slit portions may be partially cured due to less exposure dose and partially dissolved during development. Therefore, by one-pot exposure, the thickness of the red, green, and blue pixels 321R, 321G, and 321B of the color filter 321 may be adjusted to a different level for the reflection region B and the transmission region D.

The phrase “the red, green, and blue pixels 321R, 321G, and 321B of the color filter 321 have two stepped structure” means that each red, green, and blue pixel 321R, 321G, and 321B of the color filter 321 has different thicknesses for the reflection region B and the transmission region D. Therefore, the color filter 321 may have different characteristics for the reflection region B and the transmission region D.

Next, a patterned phase difference layer may be formed in operation S3.

Referring to FIG. 8D and FIG. 8E, polyimide may be printed on the color filter 321 and then rubbed to form an orientation layer (not shown). At this time, mask rubbing may be used. Mask rubbing may be performed using photolithography such that the reflection region B or the transmission region D is masked with resist and rubbed in a predetermined direction. Here, rubbing for the reflection region B may be performed at an angle of 45 degrees with respect to the transmission axis of a polarization plate (324 of FIG. 3 and FIG. 4) of the color filter substrate 320, and rubbing for the transmission region D may be performed parallel to the transmission axis of the polarization plate of the color filter substrate 320.

A UV-curable liquid crystal monomer may be spin-coated on the orientation layer to planarize the stepped color filter 321, followed by exposure, thereby forming a λ/4 phase difference layer. Since a liquid crystal polymer is oriented in the rubbing direction of the orientation layer, a phase difference layer 323R of the reflection region B may function as a λ/4 layer. However, in a phase difference layer 323NR of the transmission region D, an axis plane is parallel to the transmission axis of the polarization plate of the color filter substrate 320. Thus, no effective phase difference occurs. The UV-curable liquid crystal monomer may be polymerized under an N₂ atmosphere since insufficient polymerization is performed in the presence of oxygen.

The phase difference layer 323 may also be formed as follows. First, a liquid crystal polymer may be coated on the color filter 321 followed by photoalignment to form an orientation layer (not shown), which may be oriented in different directions for the reflection region B and the transmission region D.

A liquid crystal polymer or a UV-curable liquid crystal monomer exhibiting a nematic phase may be spin-coated on the orientation layer to planarize the stepped the color filter 321. The resultant structure may be exposed to light to form a λ/4 layer as a phase difference layer. Since the liquid crystal polymer is oriented in the rubbing direction of the orientation layer, the phase difference layer 323R of the reflection region B may function as a λ/4 layer. However, in the phase difference layer 323NR of the transmission region D, an axis plane is parallel to the transmission axis of the polarization plate of the color filter substrate 320. Thus, no effective phase difference occurs. The UV-curable liquid crystal monomer may be polymerized under an N₂ atmosphere since insufficient polymerization may be performed in the presence of oxygen. The phase difference of the phase difference layer 323 may be optionally adjusted by varying a layer thickness.

As described above, the phase difference layer 323 may be patterned with a λ/4 phase difference for the reflection region B and no phase difference for the transmission region D. Therefore, it is not necessary to add a phase difference layer to the backlight substrate 310 to compensate for the phase difference of the phase difference layer 323R used for reflection display. Consequently, fewer phase difference layers may be used as compared to a conventional LCD. Furthermore, since the phase difference layer 323 planarizes the stepped color filter 321, a separate overcoat layer is not needed, thereby simplifying a manufacturing process and decreasing manufacturing costs.

Next, a common electrode may be formed by sputtering indium tin oxide (ITO) in operation S4.

Finally, a common cell process is performed in operation S5.

Liquid crystals may be interposed between the backlight substrate 310, formed with a TFT, and the color filter substrate 320, formed with the phase difference layer 323, and sealed. Finally, polarization plates (313 and 324 of FIG. 3 and FIG. 4) are bonded to the backlight substrate 310 and the color filter substrate 320, respectively, so that the axis plane and transmission axis of the phase difference layer 323 of the transmission region D are parallel to each other.

An LCD was manufactured according to the above-described method of the present invention to compare its vertical reflection characteristics to those of a conventional LCD. Accordingly, vertical reflection characteristics (reflectivity, %) of red, green, and blue pixels under no electric field of a common black mode were calculated, and the results are as follows. The red pixel's reflectivity for the LCD of the present invention was 0.026%, while the red pixel of the conventional LCD had a reflectivity of 0.868%. With respect to a green pixel, both LCDs exhibited reflectivity of 0.013%. The reflectivity of a blue pixel of the conventional LCD was 0.204%, but that of the present invention was 0.034%. The above results show that the reflectivity of the pixels of the LCD of the present invention may be less than or equal to that of the conventional LCD. Thus, the LCD of the present invention exhibits effective color characteristics.

Further, the LCD of the present invention displayed high contrast in a reflection mode and in a transmission mode.

As apparent from the above description, an LCD and a method of manufacturing the same according to exemplary embodiments of the present invention may provide the following advantages.

First, a stepped color filter may enable adjusting color density or reproducibility and increasing reflectivity in a reflection region.

Second, since a phase difference layer planarizes a stepped surface of the color filter, a separate overcoat layer is not required, thereby simplifying a manufacturing process and decreasing manufacturing costs.

Third, a phase difference layer formed on a substrate may have different phase differences for a reflection region and a transmission region. Therefore, a reflection region may provide sufficient reflectivity and a transmission region may realize transmission display even without an additional phase difference layer to compensate for the phase difference of the phase difference layer. Conseqeuntly, fewer phase difference layers may be used, thereby resulting in thinner cells and cheaper cell manufacturing costs.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display (LCD), comprising:
a first substrate with a plurality of pixels defined, each pixel having a reflection region and a transmission region;
a color filter, formed on the first substrate, having a stepped surface; and
a phase difference layer planarizing the stepped surface of the color filter and having a first phase difference for the reflection region and a second phase difference for the transmission region,
wherein the first phase difference differs from the second phase difference.

2. The LCD of claim 1, wherein different color pixels of the color filter have different thicknesses.

3. The LCD of claim 1, wherein different color pixels of the color filter have two stepped structures.

4. The LCD of claim 3, wherein lower layers of two stepped structures of the different color pixels have different thicknesses.

5. The LCD of claim 1, wherein the first phase difference is λ/4 and the second phase difference is zero.

6. The LCD of claim 1, wherein the phase difference layer comprises a liquid crystal polymer.

7. The LCD of claim 6, wherein the liquid crystal polymer is obtained by curing a UV-curable liquid crystal monomer exhibiting a nematic phase.

8. The LCD of claim 1, further comprising:
a second substrate; and
a liquid crystal layer interposed between the first substrate and the second substrate,
wherein liquid crystals of the liquid crystal layer have a vertical orientation when no voltage is applied to the liquid crystal layer.

9. The LCD of claim 1, further comprising:
a second substrate; and
a liquid crystal layer interposed between the first substrate and the second substrate,
wherein liquid crystals of the liquid crystal layer have a horizontal orientation when no voltage is applied to the liquid crystal layer.

10. A method for manufacturing a liquid crystal display, the method comprising:
forming a color filter with a stepped surface on a first substrate;
forming a plurality of pixels, each pixel having a reflection region and a transmission region; and
forming a phase difference layer that planarizes the stepped surface of the color filter and has a first phase difference for the reflection region and a second phase difference for the transmission region,
wherein the first phase difference differs from the second phase difference.

11. The method of claim 10, wherein different color pixels of the color filter have different thicknesses.

12. The method of claim 10, wherein different color pixels of the color filter have two stepped structures.

13. The method of claim 12, wherein lower layers of two stepped structures of the different color pixels have different thicknesses.

14. The method of claim 12, wherein forming the color filter comprises exposure and development of a film coated with a photoresist composition for the color filter by a slit mask.

15. The method of claim 10, wherein the first phase difference is λ/4 and the second phase difference is zero.

16. The method of claim 10, wherein the phase difference layer comprises a liquid crystal polymer.

17. The method of claim 16, wherein the phase difference layer is formed using a liquid crystal polymer obtained by curing a UV-curable liquid crystal monomer exhibiting a nematic phase.

18. The method of claim 10, wherein forming the phase difference layer comprises:
forming an orientation layer that is oriented in different directions for the reflection region and the transmission region by photoalignment; and
coating a liquid crystal polymer or a UV-curable liquid crystal monomer exhibiting a nematic phase on the orientation layer.

19. The method of claim 10, wherein forming the phase difference layer comprises:
forming an orientation layer that is oriented in different directions for the reflection region and the transmission region by mask rubbing; and
coating a liquid crystal polymer or a UV-curable liquid crystal monomer exhibiting a nematic phase on the orientation layer.

20. The method of claim 10, further comprising:
forming a second substrate; and
interposing a liquid crystal layer between the first substrate and the second substrate,
wherein liquid crystals of the liquid crystal layer have a vertical orientation when no voltage is applied to the liquid crystal layer.

21. The method of claim 10, further comprising:
forming a second substrate; and
interposing a liquid crystal layer between the first substrate and the second substrate,
wherein liquid crystals of the liquid crystal layer have a horizontal orientation when no voltage is applied to the liquid crystal layer.
